(19) United States
(12) Patent Application Publication
(10) Pub. No.: US 2026/0317926 A1
(43) Pub. Date: Oct. 15, 2026

(54) A Separator for Alkaline Water Electrolysis

(71) Applicant: Agfa-Gevaert NV, Mortsel (BE)

(72) Inventors: Raymond Thuer, Mortsel (BE); Johan Loccufier, Mortsel (BE); Hubertus Van Aert, Mortsel (BE)

(73) Assignee: Agfa-Gevaert NV, Mortsel (BE)

(21) Appl. No.: 19/484,084

(22) PCT Filed: Dec. 19, 2024
(86) PCT No.: PCT/EP2024/087430

§ 371 Date: Nov. 13, 2025

(30) Foreign Application Priority Data
Dec. 21, 2023 (EP) 23219136.1

(51) Int. Cl. C25B 13/02; C25B 9/23; C25B 11/052; C25B 13/08

(52) U.S. Cl. CPC C25B 13/02; C25B 9/23; C25B 11/052; C25B 13/08

(57) ABSTRACT

A catalyst coated separator for alkaline water electrolysis (1) comprising a porous support (100) and on at least side of the support, in order:—an optional porous polymer layer (200),—a non-porous alkali-stable polymer layer (300), and—a catalyst layer (400).

### TECHNICAL FIELD OF THE INVENTION

The present invention relates to a separator for alkaline water electrolysis.

### BACKGROUND ART FOR THE INVENTION

Nowadays, hydrogen is used in several industrial processes, for example its use as raw material in the chemical industry and as a reducing agent in the metallurgic industry. Hydrogen is a fundamental building block for the manufacture of ammonia, and hence fertilizers, and of methanol, used in the manufacture of many polymers. Refineries where hydrogen is used for the processing of intermediate oil products are another area of use. However, the production of hydrogen from fossil fuels results in massive CO₂ emission.

Hydrogen is also being considered an important future energy carrier, which means it can store and deliver energy in a usable form. Energy is released by an exothermic combustion reaction with oxygen thereby forming water. During such combustion reaction no greenhouse gases containing carbon are emitted.

For the realization of a low-carbon society, renewable energies using natural energy such as solar light and wind power are becoming more and more important.

The production of electricity from wind power and solar power generation systems is very much dependent on the weather conditions and therefore variable, leading to an imbalance of demand and supply of electricity. To store surplus electricity, the so-called power-to-gas technology, wherein electrical power is used to produce gaseous fuel such as hydrogen, has attracted much interest in recent years. As production of electricity from renewable energy sources will increase, the demand for storage and transportation of the produced energy will also increase.

Water electrolysis is an important manufacturing process wherein renewable electricity may be converted into hydrogen. Hydrogen produced in this way is often referred to as green hydrogen, emphasizing that no greenhouse gases are formed during its production. Ammonia and steel prepared from or with green hydrogen are also referred to as green ammonia and green steel.

In an alkaline water electrolysis (AWE) cell, a porous separator is used to separate electrodes of different polarity to prevent a short circuit between these electrodes and to prevent the recombination of hydrogen (formed at the cathode) and oxygen (formed at the anode) by avoiding gas crossover. In addition, the separator should exhibit a high ionic conductivity for the transportation of hydroxyl ions from the cathode to the anode.

A separator for AWE, for example disclosed in EP-A 1776490 (VITO), WO2009/147084 and WO2009/147086 (AGFA-GEVAERT NV and VITO), typically comprises a porous polymer layer provided on a porous support. Inorganic particles, such as zirconium oxide, are added to the polymer layer to render it hydrophilic, ensuring sufficient electrolyte permeability and minimal adhesion of gas bubbles on the surface of the polymer layer.

In a typical AWE cell, a separator is placed between two electrodes, an anode and a cathode. Hydrogen is formed at the cathode as result of a Hydrogen Evolution Reaction (HER) while Oxygen is formed at the anode as result of an Oxygen Evolution Reaction (OER). Catalysts are used to minimize the overpotentials for both OER and HER. These catalysts are typically deposited on the electrodes.

However, the catalyst may also be deposited on the separator surface to further lower the overpotentials. A separator where the catalysts are deposited on one of both of their surfaces is typically referred to as catalyst coated separator or catalyst coated membrane.

Depositing catalysts on non-porous membranes, such as Proton Exchange Membranes (PEM), is disclosed in Bladergroen et al., “Overview of Membrane Electrode Assembly Preparation Methods for Solid Polymer Electrolyte Electrolyzer”, 2012, DOI: 10.5772/52947.

In AWE however, porous separators are typically used, such as those mentioned above. DE102020208003 (FRAUNHOFER GES) discloses a method wherein a catalytically active layer is deposited on a surface of the porous membrane ZIRFON PERL from AGFA-GEVAERT NV by plasma spraying. The utility model CN219315104 (UNIV TSINGHUA) discloses an apparatus for manufacturing a catalyst coated separator wherein the catalyst is sprayed on both sides of a porous separator. EP-A 4105359 (SIEMENS AG) disclose catalyst coated separators for PEM, AEM and AWE. The catalyst is deposited by Vapor Phase Deposition, for example on a ZIRFON PERL separator.

In KR2022/0073190 (KOREA RES INST CHEMICAL TECH) a porous separator has been provided with a crosslinked PVA layer containing a metal catalyst. The metal catalyst has the effect of further reducing the HTO by converting hydrogen passing through the porous membrane to water through a catalytic reaction together with oxygen, however at the expense of electrochemical efficiency. The PVA layer was also applied by an ultrasonic spray coating process.

When catalyst is deposited on the surface of a porous membrane some of the catalyst may be deposited inside the pores of the membrane. When catalyst is present inside such pores, hydrogen and/or oxygen may be formed inside the membrane. This may result in an increase of the areal resistance (decrease ionic conductivity) and/or increased gas crossover.

There is thus a need for a catalyst coated separator for AWE wherein catalyst is not deposited inside the pores of the separator.

### SUMMARY OF THE INVENTION

It is an object of the invention to provide a catalyst coated separator for alkaline water electrolysis wherein minimal catalyst is deposited inside the pores of the separator and having an improved gas permeability.

This object is realized with the separator as defined in claim 1.

Further objects of the invention will become apparent from the description hereinafter.

### BRIEF DESCRIPTION OF THE DRAWINGS

FIG. 1 schematically illustrates several embodiments of a catalyst coated separator according to the present invention.

FIG. 2 schematically illustrates an embodiment of an electrolytic cell according to the present invention.

FIG. 3 shows a SEM cross section a comparative catalyst coated separator S-1 (FIG. 3.a) and of the embodiment of a catalyst coated separator according to the present invention S-2 (FIG. 3.b), both prepared in Example 1.

FIG. 4 shows a SEM image (top-view) of a surface of the state-of-the-art separator ZIRFON (FIG. 4.a) and of a surface of a separator S-3 comprising a non-porous layer prepared in Example 2 (FIG. 4.b).

### DETAILED DESCRIPTION OF THE INVENTION

### Catalyst Coated Separator

A separator as used herein may also be referred to as diaphragm or membrane.

A catalyst coated separator for alkaline water electrolysis according to the present invention comprises a porous support (100) and one at least one side of the support, in order:
an optional porous polymer including a Polymer A (200),
a non-porous layer including a Polymer B (300), and
a catalyst layer (400).

It has been observed (see the examples) that the presence of a non-porous layer (300) between a porous support (100) or a porous layer including a Polymer A (200) and a catalyst layer (400) avoids deposition of catalyst into the pores of the porous support or porous layer including a Polymer A.

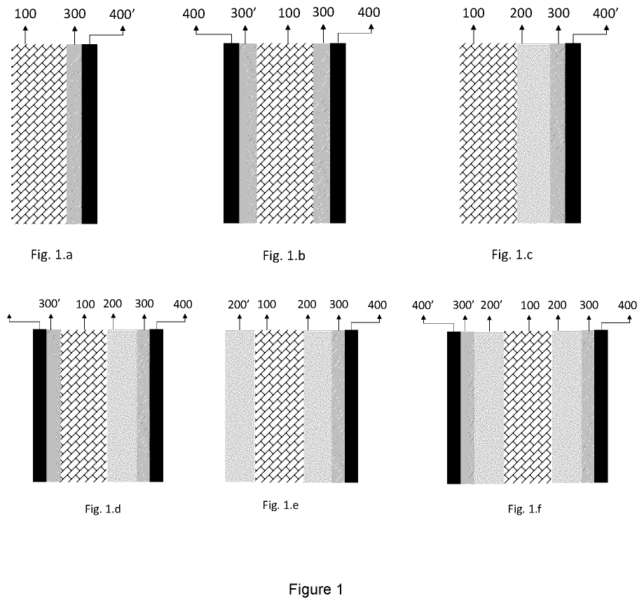

The optional porous layer including a Polymer A, the non-porous layer including a Polymer B and the catalyst layer may be, independently from each other, applied on one or both sides of the porous support. In case these layers are applied on both sides of the porous support, the optional porous layers (200 and 200′), the non-porous layers (300 and 300′) and the catalyst layers (400 and 400′) may be identical or different from each other. Different embodiments of a catalyst coated separator according to the present invention are schematically shown in FIG. 1 (FIG. 1.a to FIG. 1.f).

When only one catalyst layer is provided, for example the embodiments depicted in FIG. 1.a, FIG. 1.c and FIG. 1.e, it has been observed that the highest gain in electrolysis efficiency is obtained when the catalyst layer faces the cathode in an electrolytic cell.

The catalyst coated separator according to the present invention preferably comprises one or two porous layers including a Polymer A provided on one or both sides of the porous support, more preferably two porous layers including a Polymer A provided on either side of the porous support.

The total thickness of the catalyst coated separator is preferably from 50 to 750 μm, more preferably from 75 to 500 μm, most preferably from 100 to 250 μm. The areal resistance of the separator typically increases with the thickness of the separator increases. However, a minimal thickness is often necessary to ensure sufficient mechanical/physical properties of the separator and to facilitate manufacturing and handling of the separator.

The gas permeability of the catalyst coated separator is preferably less than 3 L/min·cm², more preferably less than 1.5 L/min·cm², most preferably less than 0.5 L/min·cm², particularly preferred less than 0.1 L/min·cm². The gas permeability is preferably measured with a Porolux™ 1000 apparatus at 5 bar. A too high gas permeability may results in an increase of the HTO (vol % hydrogen present in the oxygen stream formed at the anode).

Maximal ion-conductivity requires maximal electrolyte penetration of the electrolyte in the separator. The porosity of the catalyst coated separator is preferably from 40 to 90%, more preferably from 50 to 80%, most preferably from 60 to 70%.

The presence of the non-porous layer may not result in a substantial increase of the areal resistance of the separator. The areal resistance of the catalyst coated separator is preferably less than 0.35ohm·cm² , more preferably less than 0.25 ohm·cm², most preferably less than 0.10 ohm·cm² at 25 °C in a 30 wt % aqueous KOH solution. The areal resistance is preferably determined with an Inolab® Multi 9310 IDS apparatus available from VWR, part of Avantor, equipped with a TetraCon 925 conductivity cell available from Xylem.

The bubble point of the catalyst coated separator is preferably at least 5 bar, more preferably at least 6 bar, most preferably at least 7 bar, particularly preferred at least 8 bar, measured according to ASTM F316.

### Catalyst Layer

The catalyst coated separator according to the present invention includes a catalyst layer (400). The catalyst layer is coated on the non-porous layer (300), such that both layers are in direct contact. This means that the catalyst layer cannot be separated from this layer under normal operating conditions. When the catalyst layer is directly applied to the non-porous layer, the resulting catalytic surface may be more homogeneous, and smoother compared to when the catalyst is applied on the electrode. Thus, a “true” zero-gap configuration (see below) can be obtained, eliminating any voids between the separator and the catalyst layer. Such a smooth catalyst layer surface may be advantageous in preventing localized temperature and/or current hotspots in the separator when in contact with the electrode, thereby ensuring more efficient electron transfer and preventing local membrane degradation.

The catalyst layer facing the anode in an electrolytic cell includes one or more catalysts for the Oxygen Evolution Reaction (OER) while the catalyst layer facing the cathode in an electrolytic cell includes one or more catalysts for the Hydrogen Evolution Reaction (HER).

The thickness of the catalyst layer is preferably from 0.5 to 200 μm, more preferably from 1 to 100 μm, most preferably from 5 to 75, particularly preferred from 10 to 50 μm.

The catalyst is preferably selected from the group consisting of Ni, Ni/NiO, Ni—Fe, Ni—Co, Ni—Mn, Ni—Mo, Fe—Co, Ni—Zn, Ni—Al, Ni—Mo—Al, Ni—Co—Al, Ni—MnAl, Ni—Si, Ni—B or Ni—Si—B. A single catalyst or a combination of catalysts may be used. Preferred catalyst at the cathode side of the separator are selected from the group consisting of Ni, Raney Ni, Ni—Fe, Ni—Co and Ni—Mo. A preferred catalyst at the anode side of the separator are selected from NiO/OH and NiO The catalyst coated separator may have a catalyst layer on one or both of its surfaces. When a catalyst layer is present only on one surface, the catalyst coated separator is preferably orientated in an electrolytic cell in such a way that the catalyst layer faces the cathode. It has been observed that such an orientation results in a higher increase of the electrolysis efficiency compared to an orientation wherein the catalyst layer faces the anode.

### Non-Porous Layer Including a Polymer B

The catalyst coated separator according to the present invention includes a non-porous layer including a Polymer B between the porous support or the porous layer including a Polymer A and the catalyst layer.

The presence of the non-porous layer has the following advantages:
the catalyst is not deposited into the pores of the porous support or the porous layer(s),
the gas permeability of the catalyst coated separator decreases, and
improved contact with the catalyst layer (or the electrode) due to smoothness of the non-porous layer.

The non-porous layer including a Polymer B, described below, is non-porous in the sense that is does not have fixed pores in the traditional meaning, i.e. permanent, well-defined pores or channels like those found in porous materials. Instead, ion transport through the non-porous layer occurs through temporary, dynamic voids or free-volume regions between individual polymer chains. These voids are formed due to the thermal motion and packing arrangement of the polymer chains. However, they are not static (or “fixed”) in structure and size. The size of these dynamic voids is typically less than 5 nm, in the order of Angstroms, from 0.1-5 nm (i.e. 1-50 Å). According to the well-known solution-diffusion model, the size and chemistry of the voids allow selective transport of ions, while filtering out larger species. Thus, while the non-porous layer including a polymer B lacks fixed pores, the small and dynamic spaces between the polymer chains allow ion transport.

It is essential that the layer including polymer B does not have fixed pores (with a well-defined pore size) and is thus non-porous. When a porous layer is used, regardless of the pore size, catalyst penetration into the separator cannot be prevented. Even if the average pore size of this porous layer is small, catalyst infiltration cannot be entirely avoided. Indeed, the combination of separator's pore size distribution with the catalyst particle size distribution, along with catalyst coating techniques (which may involve the application of pressure), inevitably leads to some degree of catalyst deposition within the pores of a porous layer. However, due to the absence of pores, the non-porous layer including a Polymer B is able to entirely eliminate catalyst penetration in the separator.

The non-porous layer including a Polymer B has to withstand typical AWE conditions, such as 30 wt % KOH at 80 °C during a prolonged time. Therefore, the non-porous layer preferably includes a Polymer B that is alkali-stable making the non-porous layer and thus the separator according to the present invention suitable for alkaline water electrolysis. An alkali-stable polymer as used herein means a polymer that shows minimal degradation in polymer chain length or changes in the polymer chemistry after 4 weeks exposure to 6 M KOH at 120 °C

Also, the non-porous layer may not adversely affect the areal resistance/conductivity of the separator. Therefore, the hydroxyl permeability of the non-porous layer in the AWE conditions must be sufficient.

Also, the non-porous layer preferably includes a polymer B that is hydrophilic as this will enhance the solubility of KOH (and water) in the non-porous layer and thus will result in a decrease of the gas permeability without adversely affecting the conductivity/areal resistance. A contact angle of water on the surface of the non-porous layer, measured as described below, is preferably less than 90 degrees, more preferably less than 75 degrees most preferably less than 60 degrees. Particularly preferred, a contact angle of water on the surface of the non-porous layer is from 40 to 60 degrees. It has been observed that less adhesion of gas bubbles occurs on hydrophilic non-porous layers resulting in a lower areal resistance.

Also, the non-porous layer preferably has a smooth surface to improve the contact with the catalyst layer (or electrode). areal resistance. A smooth surface also improves contact between the separator surface and the electrodes in an electrolytic cell. It has been observed (see the examples) that the surface of the non-porous layer is indeed smoother (less rough) than the surface of state-of-the-art separators without such a non-porous layer.

The hydroxyl permeability of the non-porous layer may be tuned amongst others by the layer thickness, the nature of Polymer B, the degree of crosslinking, the crosslinker type and by blending different Polymers B in the non-porous layer. This allows for the use of a wide range of polymers having different swelling characteristics in an aqueous alkaline medium.

The Polymer B is preferably crosslinked to further increase its long-term stability in the highly alkaline electrolyte of the electrolyser wherein the separator is used.

The non-porous layers may further include other ingredients to optimize its properties or to optimize the coating process. However, the non-porous layer of the invention preferably contains at least 50 parts per weight, more preferably at least 75 parts per weight, most preferably at least 90 parts per weight of the Polymer B to ensure sufficient hydroxyl permeability and smoothness of the non-porous layer and to retain sufficient mechanical properties.

Other ingredients are, for example, surfactants (see below), inorganic particles (see below), viscosity regulators (see below) and recombination catalysts.

Preferred recombination catalysts are selected from the group consisting of NiO, Pt, Ir, IrO2 and stainless steel.

The thickness of the non-porous layer is preferably from 0.01 to 50 μm, more preferably from 0.1 to 30 μm, most preferably from 1 to 20 μm. Even more preferred, the thickness of a porous separator is from 7 to 15 μm. When the thickness of the non-porous layer is more than 50 μm, the overall resistance of the membrane may become too high. On the other hand, when the thickness of the non-porous layer is less than 0.01 μm, the non-porous layer might potentially not cover the full separator surface and might not be smooth enough to improve the contact with the catalyst layer.

### Polymer B

Polymer B may be selected from, for example, optionally modified poly-benzimidazoles, polysulfones, poly(ether sulfones), poly(ether ketones), poly(phenylene ethers), poly(ethers), poly(acetals), styrene based polymers and copolymers and poly(olefines) based polymers and copolymers. Preferred polymers have an all carbon polymer backbone.

Polymer B is preferably functionalized with nonionic hydrophilic groups, where the modification is preferably selected from the group consisting of hydroxylation and ethoxylation. Preferred hydrophilic fragments are selected from the group consisting of polyhydroxyl fragments and poly(ethylene oxide) fragments. The fragments may be part of or may be grafted on the polymer backbone. The hydrophilic fragments may be arranged in different geometries such as block copolymers or graft copolymers. Poly(ethylene glycol) based polymers or copolymers are particularly preferred, including block copolymers such as poly(olefin-block co-ethylene glycol) or graft copolymers such as poly(ethylene glycol) grafted on a poly(sulfone) or a poly(ether sulfone). Polyhydroxyl containing polymers are most preferred. Typical examples of polyhydroxy containing polymers include polysaccharides and vinyl alcohol based (co)polymers. Preferred polysaccharides include dextran and pullulan and derivatives thereof and starch derivatives. Preferred vinyl alcohol based (co)polymers include poly(vinyl alcohol), poly(ethylene-co-vinyl alcohol) and poly(ethylene-co-vinyl amine).

Polymer B is preferably selected from the group consisting of poly(ethylene glycol) or copolymers thereof, poly(saccharides), poly(ethylene-co-vinyl alcohol), poly(ethylene-co-vinyl amine) and poly(vinyl alcohol). A particularly preferred Polymer B is poly(vinyl alcohol) (PVA) or poly(ethylene-co-vinyl alcohol).

PVA is typically prepared by hydrolysis of poly(vinyl acetate). The properties of the PVA is determined by the degree of hydrolysis. Preferred hydrolysis degrees are from 50 to 100%, more preferably from 70 to 99%, most preferably from 85 to 98%. It has been observed that non-porous layers including a PVA with a high degree of hydrolysis, i.e. above 85%, are more hydrophilic and less soluble in water.

The molecular weight of polymer B is preferably from 10 to 250 kDa, more preferably from 15 to 150 kDa, most preferably from 50 to 125 kDa. It has been observed that a non-porous layer including a Polymer B with a high molecular weight, i.e., a Mw of at least 15 kDa, has an improved homogeneity. Additionally, when the Mw is lower than 15 kDA, it is possible that there are not enough chain entanglements between the polymer chains, resulting in worse film forming properties, and a lower overall durability of the separator. Although higher molecular weight polymers will result in non-porous layers with better mechanical properties, a too high molecular weight, i.e., a MW higher than 150 kDa, might be more difficult to process.

### Surfactants

The non-porous layer may include surfactants to optimize the coating process, to obtain homogeneous non-porous layers and/or to optimize the non-porous layer surface properties. Surfactants may be added to reduce the static and/or dynamic surface tension, to improve wetting on the separator surface, to improve levelling of the coated layer and to avoid coating defects such as orange peel, craters/fisheyes, mottling, Bernard cells, and Marangoni flow.

Suitable surfactants are for example modified silicone surfactants, such as silicone-polyether graft- and block copolymers or trisiloxanes. Preferred silicone polyether surfactants are Tego wet 240, Tego wet KL 248, Dynol 960, Dynol 980 and Tego Foamex 822 supplied by Evonik; Byk 348 and Byk 3450 supplied by Byk Chemie; Coatosil 7607 and Silwet L77 supplied by Momentive; and Hydropalat WE 3220 supplied by BASF. Silicone surfactants with a high hydrolytic stability are Byk 3420 supplied by Byk Chemie and Silwet HS312 and Silwet HS313 supplied by Momentive.

Another class of surfactants, which may be used are fluoro tensides, e.g. Tivida FL2500 or Tivida FL2700. However, the use of fluoro tensides is less preferred due to health and safety issues.

Other preferred surfactants are alkoxylated surfactants, such as alkyl ethoxylates or alkoxylated block copolymers. Examples are Lutensol AP6, Lutensol A8, Pluronic PE10500 and Kauropal K933 supplied by BASF; Emulgen 109P and Akypo RLM100 supplied by Kao; and Ecosurf EH 6 supplied by Dow Chemical.

Also, mixtures of a silicone additive and an alkoxylated surfactant, e.g. Kauropal K933 and Tego foamex 822, may be used.

Acetylene derivatives may be used to reduce the surface tension of the coating solution, such as Dynol 604, Surfynol 104, Surfynol 420 and Surfynol 465. Dynol 604 is an ethoxylated surfactant based on 2,5,8,11-Tetramethyldodec-6-yne-5,8-diol. Surfynol grades are based on 2,4,7,9-Tetramethyl-5-decyne-4,7-diol. Also, a hydrogenated surfynol derivative such as Surfynol AD01 may be used.

In order to optimize the compatibility with poly(vinyl alcohols), hydroxyl functional surfactants, such as alkyl polyglucoside surfactants, e.g. Glucopon 420 or Glucopon 100DK supplied by BASF; Simulsol SL 826 supplied by Seppic S.A; and polyglycidol or polyglycerol based surfactants, such as PGLAL ML04 and PGLAL ML08 supplied by Daicel Europe GmbH; and AEG 102/61, supplied by Lamberti may be used. Bio-based non-ionic surfactants like HoneySurf LF supplied by Holiferm may also be used.

Besides non-ionic surfactants, ionic surfactants may be used to improve the coating quality, i.e. anionic, cationic or amphoteric surfactants. One can also use precursors of ionic surfactants, which become ionic at low or high pH, e.g. carboxylated surfactants Akypo RLM45 and Akypo RLM100, which become anionic at a basic pH or surfactants having tertiary amine group, which become ionic at low pH. Suitable amphoteric surfactants are for example Euroglyc AMS supplied by EOC Surfactants, Arkopon T Paste 8015 supplied by Clariant and amineoxide surfactants like Makamine LO supplied by Verdant Specialty Solutions. Suitable anionic surfactants are Aerosol OT100 and Aerosol OT75E supplied by Solvay, Exodiss SE75 supplied by EOC Surfactants or Marlon A365 supplied by Sasol.

Some surfactants may be designed as anti-foam agent, for example silicone-based products or alkyl ethoxylates. Such surfactants typically have a lower HLB (hydrophilic-lipophilic balance) value. Examples of anti-foam agents are Tego Foamex 3062 or Tego Foamex 884, supplied by Evonik; Airase 5355 or Supread 2059, supplied by Elementis; and AF8014 supplied by Dow Chemical.

### Viscosity Regulators

A so-called thickener or rheology modifier may be added to the polymer B solution to optimize its viscosity.

Standard rheology modifiers, such as ASE (Alkali Swellable Emulsions), HASE (Hydrophobically Modified Alkali-soluble Emulsions) or HEUR (Hydrophobically Ethoxylated URethane polymers) based thickeners, may be used. Examples of commercially available standard rheology modifiers are Tego Visco Plus 3000, Tegovisco Plus 3010, Tafigel PUR80, ADDITOL VXW6388E, BYK-LP R 21675, Rheovis AS 1130, Rheolate 278 and Rheolate 255.

Other rheology modifiers are selected from gelatin, dextran, starch, collagen derivatives, alginate, chitosan, collodion and other polysaccharides, such as xanthan gum, arabic gum, guar gum, casein, carrageenan, pectin, albumin and cellulose based thickeners, such as methyl cellulose, CMC (carboxy methyl cellulose), HPMC (hydroxypropyl methyl cellulose) and HEC (hydroxyethyl cellulose). Other preferred thickening agents are polyethylene glycol, polyglycerol, polyglycidol or EO-PO copolymers and poly(vinyl pyrrolidone). Examples of trade names of specific thickeners are Kelzan S, Kelzan T, Kelzan RD, Natrosol 250 HR, Tylose CR1500, Satialgine S170, Tylose H4000P, Ambergum 3031, Walocel CRT10000, Dextran 60000, Biozan S, Polygel, Kelcogel, and Rheozan.

Highly preferred rheology modifiers are a high molecular weight poly(vinyl alcohol), a vinyl alcohol copolymer or a branched poly(vinyl alcohol), such as KURARAY POVAL 105 88 KX SB or KURARAY POVAL 200 88 KX SB branched PVA structures corresponding to CAS registry number 1643793-45-6. The addition of polyvinyl alcohol or vinyl alcohol copolymers as a thickener will give a good compatibility and does not change the properties of the layer to a large extent.

Other thickeners, which can be used are inorganic components such as clay, silica or other metal oxide particles. Examples are Laponite JS, Laponite RD, Levasil 300, Cab-o-sil M5, Aerosil 300, Aerosil 200, Bindzil CC151 HS, Bindzil CC301, Luvotix HT, Luvogel 4, and Luvogel LD.

### Porous Support

The catalyst coated separator according to the present invention includes a porous support. Such a porous support provides mechanical strength to the separator, facilitating its production, handling and incorporation into an electrolyser.

A thickness of the porous support is preferably 350 μm or less, more preferably 200 μm or less, most preferably 100 μm or less, particularly preferred 75 μm or less.

It has been observed that the ion conductivity of the catalyst coated separator increases when the thickness of the porous support decreases. However, to ensure sufficient mechanical properties of the catalyst coated separator, the thickness of the porous support is preferably 20 μm or more, more preferably 40 μm or more.

The porous support is preferably a non-woven fabric, a woven fabric, a mesh or a felt, more preferably a non-woven or woven fabric.

Woven fabrics typically have a better dimensional stability and homogeneity of open area and thickness. However, the manufacture of woven fabrics with a thickness of 100 μm or less is more complex resulting in more expensive fabrics. The manufacture of non-woven fabrics is less complex, even for fabrics having a thickness of 100 μm or less. Also, non-woven fabrics may have a larger open area.

The open area of the porous support is preferably from 30 to 80%, more preferably from 40 to 70%, to ensure a good penetration of the electrolyte into the support.

The fabric preferably has a fibre diameter from 10 μm to 200 μm, more preferably from 20 μm to 150 μm, most preferably from 30 μm to 100 μm. Fabrics having a lower thickness preferably have a smaller fibre diameter. For example, a fabric having a thickness of 150 μm or lower preferably contains fibres having a fibre diameter of 75 μm or lower, more preferably of 50 μm or lower, most preferably of 35 μm or lower.

To further reduce the thickness of the fabric, the ratio of the gauze thickness to the fibre diameter is preferably less than 2.0, more preferably 1.7 or less, most preferably 1.4 or less. A thinner fabric makes it possible to prepare thinner separators.

The porous support preferably includes a polymer such as for example polypropylene, polyethylene, polysulfone, polyphenylene sulfide, polyamide/nylon, polyether sulfone, polyphenyl sulfone, polyethylene terephthalate, polyether ether ketone, sulfonated polyether ether keton, monochlorotrifluoroethylene, copolymers of ethylene with tetrafluorethylene or chlorotrifluoroethylene, polyimide, polyether imide and m-aramide.

A preferred porous support includes polyphenylene sulphide (PPS) or polyether ether ketone (PEEK).

A PPS or PEEK based porous support has a high resistance to high-temperature, high concentration alkaline solutions and a high chemical stability against active oxygen evolved from an anode during the water electrolysis process. Also, PPS and PEEK can be easily processed into various forms such as a woven fabric or a non-woven fabric.

The density of the porous support is preferably between 0.1 to 0.7 g/cm³.

The porous support is preferably a continuous web to enable a manufacturing process as disclosed in EP-A 1776490 and WO 2009/147084.

The width of the web is preferably between 30 and 300 cm, more preferably between 40 and 200 cm.

### Porous Polymer Layer Including a Polymer A

The porous polymer layer comprises a Polymer A, which is capable of forming a three-dimensional porous network during a phase inversion step described below. Such polymers are described below.

The porous polymer layer may further comprise inorganic particles. Such inorganic particles typically increase the hydrophilicity of the porous polymer layer resulting in a better permeability for the electrolyte. Moreover, it has been observed that the inorganic particles may improve the alkali-resistance of the polymer. Such inorganic particles are described below.

Porous polymer layers described for state-of-the-art porous separators, such as disclosed in for example EP-A 3933069 or WO 2023/280600, both from AGFA-GEVAERT NV, may be used in the separator according to the present invention. However, the porous layers in these state-of-the-art separators are characterized by a compromise between minimal gas permeability and maximal ion-conductivity. Due to the presence of the non-porous layer in the separator according to the present invention, minimal gas permeability of the porous polymer layer is no longer necessary, and the layer may be optimized for maximal ion-conductivity.

The surface pore diameters of the porous layer may not be too large to avoid a non-homogeneous non-porous layer or too small to avoid delamination of the non-porous layer from the porous support and/or porous polymer layer. The average surface pore diameters are preferably from 0.001 to 10 μm, more preferably from 0.01 to 5 pm, most preferably from 0.1 to 1 μm. Surface pore diameters are preferably measured with Scanning Electron Microscopy.

The pores of the porous polymer layer of a separator according to the present invention may be larger compared to those of state-of-the-art separators mentioned above, again due to the presence of the non-porous layer. The porous polymer layer may even include large finger-like pores.

The porous layer including a Polymer A may be provided on one or both sides of the porous support. When two porous polymer layers are provided, these may be identical of different from each other.

Porous layers including a Polymer A provided on both sides of the separator may the same or different from each other. Such porous layer may differ in:
composition, for example different Polymers A or different inorganic particles;
thickness, as for example disclosed in WO2023/208776 (AGFA-GEVEART NV);
pore sizes or porosity, for example by applying different phase transition conditions for both layers as disclosed in EP-A 3652362 (AGFA-GEVAERT NV).

### Polymer A

The porous layer comprises a Polymer A, which is capable of forming a three-dimensional porous network, the result of a phase inversion step in the preparation of the separator, as described below. An aqueous or organic medium may be used for the phase inversion leading to the porous structure.

When using an aqueous medium for the phase inversion, Polymer A is preferably an alkali-stable polymer, which is not swellable in an alkaline aqueous medium. Polymer A is preferably selected from the group consisting of high engineering plastics and polymers having a full carbon backbone.

High engineering plastics typically consist of an aromatic hydrocarbon containing backbone. High engineering plastics are preferably selected from the group consisting of poly(sulfones), poly(ether sulfones), poly(imides), poly(ether imides), poly(amide imides), poly(phenylene sulfides), poly(phenylene oxides) and poly(ether ketones).

Full carbon backbone containing polymers, also referred to as poly(hydrocarbons), are preferably selected from the group consisting of poly(olefine) and poly(styrene) based polymer. The poly(olefine) may be fluorinated or chlorinated. Typical examples of fluorinated and chlorinated poly(hydrocarbons) are poly(vinylidene fluoride) (PVDF), poly(tetrafluorethylene) (PTFE), poly(vinyl chloride) (PVC) and poly(vinylidene chloride) (PVDC). The poly(hydrocarbons) may be pure hydrocarbon, based on non-functionalized poly(olefines) such as poly(propylene) (PP) or low density poly(ethylene). Poly(styrene) based polymers may be a pure poly(styrene) or a styrene-based copolymer such as SEBS, also known as Kraton™. Functionalized poly(olefines) may also be used, such as hydrophobically modified poly(vinyl alcohol) derivatives Typical derivatives such as hydrophobic poly(acetals), e.g. poly(vinyl butyrals), may be used as a polymer in the porous layer according to the present invention. Poly(ethylene-co-vinyl alcohol), especially the grades with a high ethylene content may also be used. In specific cases non swellable poly(esters) may be used, such as poly(ethylene terephthalate) and pol(butylene terephthalate).

When an organic medium is used as phase inversion medium, alkali-stable hydrophilic polymers may be used for the phase inversion, followed by crosslinking of the hydrophilic polymer to make the layer stable in alkaline medium. Poly(vinyl alcohol) is a particularly preferred polymer. Crosslinking with di- or polyfunctional aldehydes is particularly preferred to make the layer alkaline resistant.

Polymer A is preferably selected from the group consisting of poly(sulfone), poly(ether sulfone), poly(phenylene sulfide), poly(ether ether ketone) and poly(phenyl sulfone), poly(sulfone) being the most preferred.

The porous layer may comprise two, three or more different polymers A as described above.

The molecular weight (Mw) of Polymer A is preferably between 1000 and 250 000, more preferably between 25 000 and 250 000. When the Mw is too low, the physical strength and durability of the porous layer may become insufficient. When the Mw is too high, the viscosity of the dope solution may become too high.

Examples of poly(sulfones), poly(ether sulfones) and combinations thereof are disclosed in EP-A 3085815, paragraphs [0021] to [0032].

The total amount of Polymer A is preferably from 5 to 40 wt %, more preferably from 10 to 30 wt %, most preferably from 15 to 25 wt %, all relative to the total dry weight of the porous polymer layer.

### Inorganic Particles

The porous polymer layer may further comprise inorganic particles, for example to improve the hydrophilicity and/or the alkali-stability of the porous polymer layer. Such inorganic particles may also be incorporated into the non-porous layer to further optimize its properties.

Preferred inorganic particles are selected from metal oxides and metal hydroxides.

Preferred metal oxides are selected from the group consisting of titanium oxide, bismuth oxide, cerium oxide and magnesium oxide.

Preferred metal hydroxides are selected from the group consisting of zirconium hydroxide, titanium hydroxide, bismuth hydroxide, cerium hydroxide and magnesium hydroxide. A particularly preferred magnesium hydroxide is disclosed in EP-A 3660188, paragraphs [0040] to [0063].

Other preferred inorganic particles are sulfates of calcium, barium, lead or strontium, barium sulfate particles being more preferred. Such barium sulfate particles are disclosed in EP-A 3994295.

Still other inorganic particles that may be used are nitrides and carbides of Group IV elements of the periodic table.

A combination of one or more different inorganic particles may be used.

The inorganic particles may be natural substances or synthetic substances.

The surface of the inorganic particles may be untreated or may be surface treated with for example a silane coupling agent, stearic acid, oleic acid, or a phosphoric acid ester.

The shape of the inorganic particles is not particularly limited as long as it is in the form of particles and may be any of irregular shapes, spherical shapes, such as true spherical shapes, and oblong spherical shapes, plate shapes, such as flake shapes and hexagonal plate shapes, and fibrous shapes.

The inorganic particles preferably have a d 50 particle size from 0.05 to 2.0 μm, more preferably from 0.1 to 1.5 μm, most preferably from 0.15 to 1.00 μm, particularly preferred from 0.2 to 0.75 μm. The d 50 particle size is preferably 0.7 μm or less, more preferably 0.55 μm or less, most preferably 0.40 μm or less.

The total amount of inorganic particles is preferably from 30 to 95 wt %, more preferably from 50 to 92 wt %, most preferably from 60 to 90 wt %, all relative to the total dry weight of the porous layer including a Polymer A. The amount of inorganic particles is preferably at least 65 wt %, more preferably at least 75 wt %, all relative to the total dry weight of the porous layer including a Polymer A.

The weight ratio of inorganic particles to polymer in the porous layer including a Polymer A is preferably 60/40 or more, more preferably 70/30 or more, most preferably 75/25 or more.

### Preparation of the Catalyst Coated Separator

A preferred preparation method of a catalyst coated separator according to the present invention comprises the steps of:
providing a porous support (100),
optionally applying a dope solution described below on the porous support and performing phase inversion on the applied dope solution thereby forming a porous polymer layer (200) on the porous support,
applying a Polymer B solution on the porous support or the optional porous layer including a Polymer A, thereby forming a non-porous layer including a Polymer B (300), and
applying a catalyst composition on the non-porous layer thereby forming a catalyst layer(s) (400).

After the application of the non-porous layer, a drying step is preferably carried out to remove at least partially the solvents of the coating solutions. Drying is preferably carried out at a temperature from 60 to 90 °C during 5 to 20 minutes.

The optional porous layer including a Polymer A, the non-porous layer including a Polymer B and the catalyst layer may be, independently from each other, applied on one or both sides of the porous support. In case these layers are applied on both sides of the porous support, the optional porous layers (200 and 200′), the non-porous layers (300 and 300′) and the catalyst layers (400 and 400′) may be identical or different from each other.

The catalyst coated separator according to the present invention may also be prepared starting from a porous separator prepared as described in WO2023/280600 or WO2023/208776, both from AGFA-GEVAERT NV. A Polymer B solution is then applied on one or both sides of such porous separators thereby forming one or two non-porous layers including a Polymer B followed by the application of a catalyst composition on the non-porous layer(s) thereby forming one or two catalyst layer(s).

### Application of the Non-Porous Layer Including a Polymer B

The non-porous layer including a Polymer B is preferably prepared by coating on the porous support (100) or the optional porous layer a Polymer B solution having a viscosity of at least 400 mPa·s, preferably at least 500 mPa·s, mor preferably at least 800 mPa·s, most preferably at least 1000 mPa·s, measured at 20 °C and a shear rate of 100 s⁻¹.

Any coating technique may be used to apply the Polymer B solution. Preferred coating techniques are selected from the groups consisting of slot-die coating, curtain coating, blade coating, bar coating, air knife coating, cascade coating, extrusion coating, reverse roll coating, kiss coating and dip coating. Highly preferred coating techniques are air knife coating, cascade coating, curtain coating, reverse roll coating, slot-die coating and kiss coating.

For an efficient and cost-effective production process of the separator, the non-porous layer is preferable applied in a single coating step.

The solvent of the Polymer B solution is dependent on the type of Polymer B. When Polymer B is a hydrophilic polymer, such as PVA, the Polymer B solution is preferably an aqueous solution. The aqueous solution may however include organic water-soluble solvents, such as for example ethanol, isopropanol, DMSO or a mixture thereof. However, most preferably the solvent is water.

Polymer B is preferably crosslinked. It has been observed that crosslinking improves the lifetime of the non-porous layer in the electrolyser. In case Polymer B is a poly(vinyl alcohol) or an ethylene vinyl alcohol copolymer the crosslinking is preferably carried out with di- or polyfunctional aldehydes, such as glutaraldehyde and benzene-1,4-dialdehyde. The aldehyde functional group reacts with the hydroxyl group of the poly(vinyl alcohol) or the ethylene vinyl alcohol copolymer forming an acetal bond. For example, crosslinked polyvinyl alcohol may be obtained through vapor phase crosslinking of polyvinyl alcohol and glutaraldehyde as described by KIM et al. (Journal of Power Sources 524 (2022) 231059). However, the crosslinking compound is preferably added to the Polymer B solution together with a crosslinking catalyst, in case of PVA and glutaraldehyde an acid catalyst, such as H₂SO₄ or HCl. The mixture is then stirred while crosslinking takes place. When a desired viscosity has been reached, the mixture is then coated on the porous support or porous polymer layer. To avoid a too high increase of the viscosity of the mixture before coating, the crosslinking agent or de acid catalyst may be added to the PVA solution just before coating. Alternatively, a separator coated with crosslinked polyvinyl alcohol may also be obtained by the following synthesis procedure. A crosslinking mixture is prepared by adding polymer B, crosslinker and catalyst in preselected concentrations to a suitable solvent. The crosslinking mixture is homogenized by stirring. The desired viscosity of the crosslinking mixture is obtained by adding viscosity modifiers or by selecting a high enough initial polymer concentration. Next, the crosslinking mixture is immediately coated on the substrate without awaiting crosslinking to take place. The coated substrate is then allowed a certain time for crosslinking to take place before being dried in an oven.

Other crosslinking compounds such as epoxides and sulfonamides may also be used. Also, a combination of crosslinking compounds may be used.

After the application of the non-porous layer, a drying step is preferably carried out to remove at least partially the solvents of the coating solutions. Drying is preferably carried out at a temperature from 60 to 90 °C during 5 to 20 minutes.

In a cost-effective, large scale manufacturing process, the non-porous layer including a Polymer B is preferably applied on at least one side of the porous support and/or the porous layer including Polymer A in a continuous roll-to-roll process.

### Application of the Catalyst Layer

The catalyst may be applied by any application method, for example those disclosed in Bladergroen et al., “Overview of Membrane Electrode Assembly Preparation Methods for Solid Polymer Electrolyte Electrolyzer”, 2012, DOI: 10.5772/52947. A well-known application method is the so-called decal method. In this method the catalyst layer is first deposited on a temporary substrate, for example fiberglass reinforced Teflon. In case two catalyst layers are applied, a separator is then sandwiched between two catalyst-coated decals with the catalyst layers facing each other. The catalyst layers are then transferred from the decal to the separator using a hot press followed by the removal of the decals.

The catalyst may also be provided directly on the surface of the separator for example by:
electrically assisted catalyst deposition, such as electro deposition, electro spraying and electrophoretic deposition;
application of the catalyst as vapour, such as magnetron sputtering and chemical vapour deposition;
plasma spraying;
dry spraying;
phase inversion;
coating, such as slot-die coating, curtain coating, blade coating, bar coating, air knife coating, cascade coating, extrusion coating, reverse roll coating, kiss coating and dip coating. Preferred coating techniques are air knife coating, cascade coating, curtain coating, reverse roll coating, slot-die coating and kiss coating.
printing, such a screen printing, gravure printing, inkjet printing, flexographic printing and 3D printing.

Preferred deposition methods are those that do not damage the non-porous polymer layer.

The catalyst layer(s) are preferably applied in-line in a manufacturing apparatus to provide an efficient and cost-effective production process.

When a coating or printing method is used to deposit the catalysator a catalyst composition is respectively coated or printed on a surface of a separator. Such a catalyst composition includes one or more catalyst(s) and may further comprise a binder, a solvent and further ingredients such as surfactants,

### Application of the Porous Layer Including a Polymer A

The optional porous layer including a Polymer A is provided on a porous support by applying a dope solution described below on at least one side of the porous support and performing phase inversion on the applied dope solution(s) thereby forming at least one porous layer including a Polymer A on the porous support.

The applied dope solution preferably completely impregnates the porous support before performing the phase inversion.

The methods disclosed in EP-A 1776490 and WO 2009/147084 may be used for applying porous layers on a porous support. Other suitable manufacturing methods that may be used are disclosed in EP-A 3272908, EP-A 3660188 and EP-A 3312306.

### Dope Solution

The dope solution preferably comprises a polymer A described above and a solvent. The dope solution may further comprise inorganic particles described above.

The solvent of the dope solution is preferably an organic solvent wherein the polymer resin can be dissolved. Moreover, the organic solvent is preferably miscible in water.

The solvent is preferably selected from N-methyl-pyrrolidone (NMP), N-ethyl-pyrrolidone (NEP), N-butyl-pyrrolidone (NBP), N,N-dimethylformamide (DMF), formamide, dimethylsulfoxide (DMSO), N,N-dimethylacetamide (DMAC), acetonitrile, and mixtures thereof. A highly preferred solvent, for health and safety reasons, is N-butyl-pyrrolidone (NBP).

The dope solution may further comprise other ingredients to optimize the properties of the obtained polymer layers, for example their porosity and the maximum pore diameter at their outer surface.

The dope solution preferably comprises an additive to optimize the pore size at the surface and inside of the porous layer. Such additives may be organic or inorganic compounds, or a combination thereof.

Organic compounds which may influence the pore formation in the porous layers include polyethylene glycol, polyethylene oxide, polypropylene glycol, ethylene glycol, tripropylene glycol, glycerol, polyhydric alcohols, dibutyl phthalate (DBP), diethyl phthalate (DEP), diundecyl phthalate (DUP), isononanoic acid or neodecanoic acid, polyvinylpyrrolidone, polyvinyl-alcohol, polyvinylacetate, polyethyleneimine, polyacrylic acid, methylcellulose and dextran.

Preferred organic compounds which may influence the pore formation in the porous layers are selected from polyethylene glycol, polyethylene oxide and polyvinyl pyrrolidone. A preferred polyethylene glycol has a molecular weight of from 10 000 to 50 000, a preferred polyethylene oxide has a molecular weight of from 50 000 to 300 000, and a preferred polyvinylpyrrolidone has a molecular weight of from 30 000 to 1 000 000. A particularly preferred organic compound which may influence the pore formation in the porous layers is glycerol. The amount of compounds which may influence the pore formation is preferably between 0.1 and 15 wt %, more preferably between 0.5 and 5 wt % relative to the total weight of the dope solution. Inorganic compounds which may influence the pore formation include calcium chloride, magnesium chloride, lithium chloride and barium sulfate.

A combination of two or more additives that influence the pore formation may be used.

The dope solutions provided on either side of the porous support may be the same or different.

### Application of the Dope Solution

The dope solution may be applied on the surface of a porous support by any coating or casting technique.

A preferred coating technique is extrusion coating. In a highly preferred embodiment, the dope solutions are applied by a slot die coating technique wherein two slot coating dies are located on either side of a porous support. The slot coating dies are capable of holding the dope solution at a predetermined temperature, distributing the dope solutions uniformly over the support, and adjusting the coating thickness of the applied dope solutions.

The viscosity of the dope solutions measured at a shear rate of 100 s⁻¹ and a temperature of 20 °C is preferably at least 7.5 Pa·s, more preferably at least 15 Pa·s, most preferably at least 30 Pa·s. The dope solutions are preferably shear-thinning. The ratio of the viscosity at a shear rate of 1 s⁻¹ to the viscosity at a shear rate of 100 s⁻¹ is preferably at least 2, more preferably at least 2.5, most preferably at least 5.

Immediately after their application, the porous support becomes impregnated with the dope solutions. Preferably, the porous support becomes fully impregnated with the applied dope solutions.

### Phase Inversion Step

After applying the dope solution onto a porous support, the applied dope solution is subjected to phase inversion. In the phase inversion step, the applied dope solution is transformed into a porous layer.

In a preferred embodiment, both dope solutions applied on a porous support are subjected to phase inversion.

Any phase inversion mechanism may be used to prepare the porous hydrophilic layers from the applied dope solutions.

The phase inversion step preferably includes a so-called Liquid Induced Phase Separation (LIPS) step, a Vapour Induced Phase Separation (VIPS) step or a combination of a VIPS and a LIPS step. The phase inversion step preferably includes both a VIPS and a LIPS step.

Both LIPS and VIPS are non-solvent induced phase-inversion processes.

In a LIPS step the porous support provided with the dope solution(s) is contacted with a non-solvent that is miscible with the solvent of the dope solution.

Typically, this is carried out by immersing the porous support provided with the dope solution(s) into a non-solvent bath, also referred to as coagulation bath.

The non-solvent is preferably water; mixtures of water and an aprotic solvent selected from the group consisting of N-methylpyrrolidone (NMP), N-ethyl-pyrrolidone (NEP), N-butylpyrrolidone (NBP), dimethylformamide (DMF), dimethylsulfoxide (DMSO) and dimethylacetamide (DMAC); water solutions of water-soluble polymers such as PVP or PVA; or mixtures of water and alcohols, such as ethanol, propanol or isopropanol. The non-solvent is most preferably water. However, when using a water-soluble, hydrophilic Polymer A, the non-solvent is preferably an organic solvent.

The temperature of the coagulation bath is preferably between 20 and 90 °C, more preferably between 40 and 70 °C.

The transfer of solvent from the coated polymer A layer towards the non-solvent bath and of non-solvent into the polymer A layer leads to phase inversion and the formation of a three-dimensional porous polymer network. The impregnation of the applied dope solution into the porous support results in a sufficient adhesion of the obtained hydrophilic layers onto the porous support.

In a VIPS step, the porous support coated with the dope solutions is exposed to non-solvent vapour, preferably humid air.

Preferably, the coagulation step included both a VIPS and a LIPS step. Preferably the VIPS step is carried out before the LIPS step. In a particular preferred embodiment, the porous support coated with the dope solutions is first exposed to humid air (VIPS step) prior to immersion in a water bath (LIPS step).

After the phase inversion step, preferably the LIPS step in the coagulation bath, a washing step may be carried out.

After the phase inversion step, or the optional washing step, a drying step may be carried out.

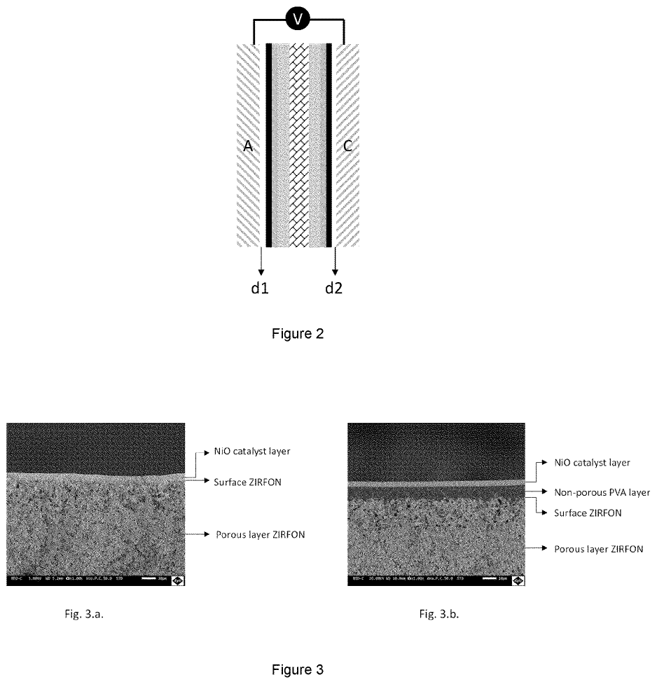

A preferred method to prepare porous polymer A layers on a porous support is disclosed in EP-A 3933069 (AGFA-GEVAERT NV), paragraphs 117 to 129 and FIGS. 2 and 3.

### Electrolytic Cell

The catalyst coated separator for alkaline water electrolysis according to the present invention may be used in an alkaline water electrolyser.

Such an electrolyser typically includes at least one electrolytic cell comprising two electrodes, an anode (A) and a cathode (C), separated by a separator. An electrolyte is present between both electrodes. A catalyst is typically provided on the electrodes, however in an electrolytic cell according to the present invention a catalyst is provided on at least one side of the separator. An embodiment of an electrolytic cell according to the present invention is schematically represented in FIG. 2.

In case a catalyst is provided on only one side of the separator, a catalyst may also be applied on the electrode facing the other side of the separator.

The electrodes are preferably made from electrically conductive materials selected from the group consisting of nickel, iron, soft steels, stainless steels, vanadium, molybdenum, copper, silver, manganese, platinum group elements, graphite, and chromium. The electrodes may be made from an electrically conductive alloy of two or more metals or a mixture of two or more electrically conductive materials. A preferred material is nickel or nickel-based alloys. Nickel has a good stability in strong alkaline solutions, has a good conductivity and is relatively cheap.

A catalyst layer provided on an electrode preferably includes nickel, cobalt, iron, and platinum group elements. The catalyst layer may include these elements as elemental metals, compounds (e.g., oxides), composite oxides or alloys made of multiple metal elements, or mixtures thereof. Preferred catalyst layers include plated nickel, plated alloys of nickel and cobalt or nickel and iron, complex oxides including nickel and cobalt such as LaNiO₃, LaCoO₃, and NiC₂O₄, compounds of platinum group elements such as iridium oxide, or carbon materials such as graphene.

A particularly preferred catalyst layer comprises Raney Nickel. The Raney nickel structure is formed by selectively leaching aluminium or zinc from a Ni—Al or Ni—Zn alloy. Lattice vacancies formed during leaching result in a large surface area and a high density of lattice defects, which are active sites for the electro-catalytic reaction to take place.

A schematic presentation of an embodiment of an electrolytic cell according to the present invention is shown in FIG. 2. A catalyst coated separator comprising a catalyst layer, a non-porous layer and a porous polymer layer provided on both sides of a porous support (see FIG. 1.f) is positioned between an anode (A) and a cathode (C). As the catalyst coated separator includes catalyst layers on both sides, no catalyst is present on the electrodes.

When electrical current is supplied to the electrolytic cell, hydroxyl ions of the electrolyte are oxidized into oxygen at the anode and water is reduced to hydrogen at the cathode. The hydroxyl ions formed at the cathode migrate through the separator to the anode. The separator prevents mixing of the hydrogen and oxygen gases formed during electrolysis.

An electrolyte solution is typically an alkaline solution. Preferred electrolyte solutions are aqueous solutions of electrolytes selected from sodium hydroxide or potassium hydroxide. Potassium hydroxide electrolytes are often preferred due to their higher specific conductivity. The concentration of the electrolyte in the electrolyte solution is preferably from 20 to 40 wt %, relative to the total weight of the electrolyte solution.

The temperature of the electrolyte is preferably from 50 °C to 120 °C, more preferably from 75 °C to 100 °C, most preferably from 80 to 90 °C. However, a higher temperature, for example at least 100 °C, more preferably from 125 to 165 °C may result in a more efficient electrolysis.

In a so-called zero gap electrolytic cell the electrodes are placed directly in contact with the separator thereby reducing the space between both electrodes. Mesh-type or porous electrodes are used to enable the separator to be filled with electrolyte and for efficient removal of the oxygen and hydrogen gases formed. Preferred porous electrodes and methods to prepare them are disclosed in for example EP-A 3575442, paragraphs 23 to 84. The pore size of porous electrodes may have an influence on the electrolysis efficiency. For example, in EP-A 3575442 it is disclosed that preferred pore sizes of the porous electrodes are from 10 nm up to 200 nm.

It has been observed that such zero gap electrolytic cells operate at higher current densities.

However, in such a zero-gap electrolytic cell it has been observed in WO2023/118088 (AGFA-GEVAERT NV) that gas bubbles formed inside the separator may accumulate at the top of the separator. Such accumulation of gas bubbles at the top of the separator may result in a higher ionic resistance in that part of the cell. A temperature rise as a result of less efficient cooling by the electrolyte in that area of the electrolysis cell may even result in burning of the separator.

Introducing a small distance between one side of the separator and at least one electrode may result in less accumulation of gas bubbles inside the separator. The distance between one side of the separator and the anode (d1) and the distance between the other side of the separator and the cathode (d2) may be the same or different. The distance between a surface of the separator and at least one electrode is preferably from 50 up to 500 μm, more preferably from 100 up to 250 μm.

Barros et al. (International Journal of Hydrogen Energy, Vol. 49, Part C, Pages 886-896) observed that a small distance between the separator surface and the electrode including the catalyst layer may decrease the supersaturation of gasses dissolved in the electrolyte at the separator surface. A high supersaturation at the separator surface may result in a higher gas diffusion through the separator. For example, a high supersaturation of hydrogen in the electrolyte at the surface of the separator facing the cathode may result in a higher HTO. A small distance d2 between the cathode and the separator surface facing the cathode may decrease the supersaturation of hydrogen at the separator surface and therefore decrease the HTO. An optimal distance d2 was found to be around 100 μm.

A so-called spacer may be used to realize the distance between the separator and the electrode. Such a spacer is preferably hydrophilic to avoid adhesion of gas bubbles to the spacer (static water contact angle is 90 °C or lower, preferably 45 °C or lower). Such a spacer preferably has an open structure to ensure ionic conductivity and efficient evacuation of gas bubbles.

When using a separator according to the present invention in an electrolytic cell, the distance d2 between the porous surface of the separator (surface of the porous support and/or the surface of the porous layer including a Polymer A) and the electrode may established by the non-porous layer.

The non-porous layer of the catalyst coated separator may also have an influence on the gas permeability. Therefore, when the catalyst coated separator includes one catalyst layer deposited on a non-porous layer, it is preferred that the catalyst layer faces the cathode. This orientation may further reduce the HTO.

A typical alkaline water electrolyser includes several electrolytic cells, also referred to stack of electrolytic cells. Regarding the cell configuration, two types of electrolysers are typically used.

A unipolar (or “tank-type”) electrolyser consists of alternate positive and negative electrodes held apart by a separator. Positive electrodes are all coupled together in parallel, as are the negative electrodes, and the whole assembly is immersed in a single electrolyte bath (“tank”) to form a unit cell. A plant-scale electrolyser is then built up by connecting these units electrically in parallel. The total voltage applied to the whole electrolysis cell is the same as that applied to the individual unit cells. On the other hand, in a bipolar electrolyser a metal sheet (or “bipole”) connects electrically adjacent cells in series. The electrocatalyst for the negative electrode is coated on one face of the bipole and that for the positive electrode of the adjacent cell is coated on the reverse face. In this case, the total cell voltage is the sum of the individual unit cell voltages. Therefore, a series-connected stack of such cells forms a module that operates at a higher voltage and lower current than the tank-type (unipolar) design. To meet the requirements of a large electrolysis plant, these modules are connected in parallel so as to increase the current.

### EXAMPLES

### Materials

ZIRFON is Zirfon Perl UTP500 from AGFA-GEVAERT NV.
PVA is a high molecular weight polyvinyl alcohol with a molecular weight of 85-124 kDa and degree of hydrolysis>99% from ALDRICH.
Glutardehyde available from ALDRICH as a 25 wt % aqueous solution.
NIO is nickeloxide (99% purity) available from BCR GMBH & CO.
PVP is polyvinylpyrolidone having a MW of 8000 available from BCR GMBH & CO.
NiO dispersion was prepared by mixing by weight: 60% NIO, 7.5% PVP and 32.5% demineralized water. This mixture was then grinded on an agitated bead mill until the Z-average particle size was smaller than 200 nm.

### Measurements

### Scanning Electron Microscopy (SEM) and Energy-Dispersive X-Ray Spectroscopy (SEM-EDX)

SEM cross-sections were prepared by cutting the sample and embedding it in epoxy resin. Afterwards, the sample was mechanically polished and coated with a thin Pt—Pd layer. Surface samples were cut and applied to an aluminum stub with double-sided tape and coated with a thin Pt—Pd layer.

### Bubble Point, Minimal Pore Size, Mean Pore Size, Gas Permeability

The pore diameters of the separators were measured using the so-called Bubble Point Test method.

The Bubble Point Test Method entails wetting of the pores of a membrane with a wetting liquid and consequently measuring the lowest pressure that is required to overcome the surface tension forces between the wetting liquid and the pore wall in a fully wetted pore. This pressure is referred to as the bubble point pressure.

The theory of capillarity states that the height of a water column in a capillary is indirectly proportional to the capillary diameter. By using the Young-Laplace equation, the pore diameter of the membrane can be linked to the applied pressure required to force the wetting liquid out of the pore.

The procedure for the bubble point test method is described in American Society for Testing and Materials Standard (ASMT) Method F316.

The top of the filter is placed in contact with the liquid, the bottom with air, the filter holder is connected to a source of a regulated pressure. The air pressure is gradually increased and the formation of bubbles on the liquid side is noted. At pressures below the bubble point, gas passes across the filter only by diffusion, but when the pressure is high enough to dislodge liquid from the pores, bulk flow begins and bubbles will be seen.

The initial bubble test pressure determines the size (and location) of the largest hole, the open bubble point pressure determines the mean pore size of the element.

The Bubble point, the average pore diameter, the maximum pore diameter and the gas permeability of the separators were measured using a POROLUX 1000, commercially available from POROMETER.

### Example 1

### Preparation of the Catalyst Coated Separator S-1 and S-2

Catalyst coated separator S-1 was prepared by coating the NiO dispersion on one side of a ZIRFON separator.

Catalyst coated separator S-2 was prepared by first coating a PVA solution at a wet coating thickness of 200 μm on one side of a ZIRFON separator followed by drying in an oven at 80 °C, forming a dry PVA layer. Next, the NiO dispersion was coated on the dried PVA layer.

A SEM cross-section of S-1 and S-2 is shown in FIG. 3.a and FIG. 3.b respectively.

From these SEM cross-sections can be derived that the thickness of the NiO catalyst layer of S-1 and S-2 and of the PVA layer of S-2 is respectively 3-4 μm and 7-8 μm.

Whether or not NiO penetrated into the pores of the ZIRFON separator was investigated using SEM-EDX. SEM-EDX analysis of the cross-sections of the separators S-1 and S-2 revealed that for S-1, Ni could be detected 20-30 μm beneath the ZIRFON surface, while for S-2, no Ni could be detected at or below the ZIRFON Surface. This clearly illustrates that the presence of the non-porous alkali-stable polymer layer between the catalyst layer and the surface of the porous separator prevents penetration of the catalysator into the pores of the porous separator.

### Example 2

### Preparation of the Separator S-3

The separator S-3 was prepared by coating a PVA solution (19 wt % in water) at a wet coating thickness of 60 μm on one side of a ZIRFON separator followed by drying at 80 °C for 15 minutes in a standard oven.

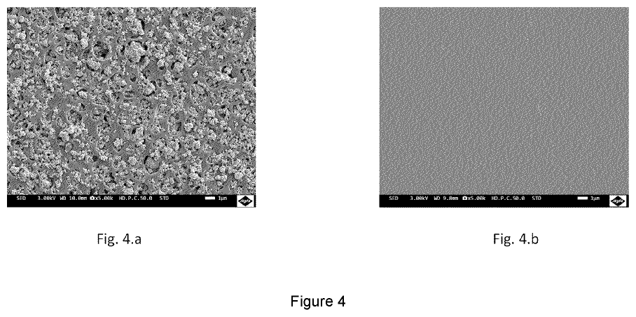

The effect of coating ZIRFON with a PVA solution on the separator surface roughness is demonstrated in FIG. 4. A SEM top-view of a surface of ZIRFON not comprising a PVA layer (FIG. 4.a) and of S-3 comprising a PVA layer (FIG. 4.b) clearly illustrates that a smoother separator surface is observed for S-3.

The gas permeability and bubble point, measured as described above, of S-3 are respectively 0.01 L/min·cm² and >8 bar and for ZIRFON respectively 3.8 and 1.9 bar. This clearly illustrates that the presence of the non-porous PVA layer results in a substantial decrease of the gas permeability and an increase of the bubble point.

1-15. (canceled)

16. A catalyst coated separator for alkaline water electrolysis comprising a porous support and on at least one side of the support, in order:
an optional porous layer including a Polymer A,
a non-porous layer including a Polymer B, and
a catalyst layer.

17. The catalyst coated separator for alkaline water electrolysis of claim 16, wherein Polymer B is selected from the group consisting of poly(ethylene glycol) or copolymers thereof, poly(saccharides), poly(ethylene-co-vinyl alcohol), poly(ethylene-co-vinyl amine), and poly(vinyl alcohol).

18. The catalyst coated separator for alkaline water electrolysis of claim 17, wherein Polymer B is poly(vinyl alcohol) or poly (ethylene-co-vinyl alcohol).

19. The catalyst coated separator for alkaline water electrolysis of claim 18, wherein the poly(vinyl alcohol) has a Molecular Weight from 75 to 150 kDa.

20. The catalyst coated separator for alkaline water electrolysis of claim 16, wherein the non-porous layer is crosslinked.

21. The catalyst coated separator for alkaline water electrolysis of claim 16, wherein the thickness of the non-porous layer including a Polymer B is from 0.1 to 25 μm.

22. The catalyst coated separator for alkaline water electrolysis of claim 16, wherein the thickness of the catalyst layer is from 0.5 to 200 μm.

23. The catalyst coated separator for alkaline water electrolysis of claim 16, wherein the catalyst is selected from the group consisting of Ni, NiO, Raney Ni, Ni—Fe, Ni—Co, Ni—Mo and NiO/NiOH.

24. The catalyst coated separator for alkaline water electrolysis of claim 16, wherein the total thickness of the separator is from 50 to 750 μm.

25. The catalyst coated separator for alkaline water electrolysis of claim 16, wherein Polymer A is selected from the group consisting of poly(sulfone), poly(ether sulfone), poly(phenylene sulfide), poly(ether ether ketone), and poly (phenyl sulfone).

26. A method of preparing a catalyst coated separator as defined in claim 16 comprising the steps of:
providing a porous support,
optionally applying a dope solution including a Polymer A on a porous support and performing a phase inversion step on the applied dope solution thereby forming a porous layer including a Polymer A on the porous support,
applying a Polymer B solution on the porous support or the optional porous layer thereby forming a non-porous polymer layer, and
applying a catalyst composition on a non-porous layer thereby forming a catalyst layer.

27. The method of claim 26, wherein the viscosity of the Polymer B solution is at least 400 mPa·s, measured at 20 °C and a shear rate of 100 s⁻¹.

28. The method of claim 26, wherein the Polymer B solution is applied by a single coating step.

29. An electrolytic cell for alkaline water electrolysis comprising a catalyst coated separator as defined in claim 16.
